(19) United States
(12) Patent Application Publication
(10) Pub. No.: US 2014/0286596 A1
(43) Pub. Date: Sep. 25, 2014

(54) PACKAGING MATERIAL, PACKAGE PRODUCED THEREFROM AND METHOD FOR CONSTRUCTING THE PACKAGE

(71) Applicant: Yi Xin Chew, Singapore (SG)

(72) Inventor: Yi Xin Chew, Singapore (SG)

(21) Appl. No.: 14/352,959

(22) PCT Filed: Oct. 15, 2012
(86) PCT No.: PCT/SG2012/000385

§ 371 Date: Apr. 18, 2014

(30) Foreign Application Priority Data
Oct. 18, 2011 (SG) 201107612-2

(51) Int. Cl. B65D 27/12; B32B 3/26

(52) U.S. Cl. CPC B65D 27/12; B32B 3/266
USPC 383/42; 428/43

(57) ABSTRACT

The present invention provides packaging material for making packages, comprising a breakable film; and a substrate on which the breakable film is positioned, wherein the substrate comprises a chemically resistant and non-heat sealable (NHS) layer having a first surface and a second surface, and a heat sealable (HS) layer bonded to the first surface of the NHS layer, and the breakable film is laminated onto the second surface of the NHS layer, and wherein at least one die cut line to define a preformed hole is formed through the NHS and HS layers. The invention also provides a package produced therefrom and a method for constructing the package.

### FIELD OF THE INVENTION

This invention relates generally to the field of package system, and more particularly, to a packaging material having good chemical resistance and having at least one preformed hole, a package produced therefrom which is suitable to contain chemical components-based products such as perfumes or air fresheners, and a method for constructing the package.

### BACKGROUND OF THE INVENTION

Packaging is an important feature in selling and marketing most products. Many and various forms of container used as packages for receiving solid and liquid products have been extensively described in the art, and materials used for making the packages are various too.

One example of the packages in the art is reclosable wet tissue packaging on which a sticker with adhesive is provided to cover the opening of the package. However, adhesives are generally not resistant to chemical components. Upon contact, the chemical components dissolve or degrade the adhesive, causing the sticker to lift off and hence opening the package prior to product usage.

A further example of the packages is blister packaging which is the type of preformed plastic packaging used for small consumer goods, for example tablet or capsule. The seal between the aluminum foil lid and the plastic carrier base is achieved through a heat activated adhesive commercially known as “Heat Seal Lacquer”. The Heat Seal Lacquer has poor resistance to chemical components. Upon contact, the chemical components dissolve or degrade the Heat Seal Lacquer, causing the aluminum foil lid to lift off and hence opening the packaging prior to product usage.

Another example of the packages is beverage container with straw hole or pull tab. The beverage container is usually made of a laminate material comprising polyethylene/aluminum foil/polyethylene/paper/polyethylene, with polyethylene being the inner most surface of the packaging in contact with the product. Polyethylene is not chemically resistant and allows the chemical components to permeate and delaminate the interface between polyethylene and aluminum foil, causing the packaging to lose its integrity.

A common drawback of the packages of the above types is that external aid is required for creation of openings at the point of usage. For the reclosable wet tissue packing, an external sticker with adhesive is utilized to remove the material from the preformed hole to expose the hole; for the blister packaging, upon application of a force, the hard product (tablet/capsule) packaged therein breaks through the aluminum foil, creating an opening through which the product can be removed; and for the beverage packaging, a plastic straw with a pointed tip is used to pierce through the aluminum foil to create an opening in the package for insertion of the straw, or a separate external flap sealed to the packaging covering a hole is removed to expose the hole. Because of the requirement of the external aid for the creation of the openings, use of at least two different materials, for example the packaging material and the sticker used for the reclosable wet tissue packaging, is needed. This would increase the manufacturing costs to some extent.

A second common drawback of the prior packages is that one or more openings are being formed on a same plane of the packaging to allow removal of the product packaged therein. This may cause an inconvenience in some cases where formation of a plurality of holes in different planes or different directions is necessary.

Although a variety of packages materials or packages exist in the prior art, these packages either require an external aid for the creation of the openings in the packages, or allow for the formation of the openings in one plane only. Therefore, the invention entails the task of creating a simple and cost-effective packaging material and a package produced therefrom that exhibits excellent chemical resistance and does not require any external aid for the creation of the openings. Moreover, the packaging material of the invention enables a user to remove the opening with ease.

### SUMMARY OF THE INVENTION

The present invention has been developed to fulfill the needs noted above and therefore has a principle object of the provision of a packaging material for making packages which is suitable for packaging products that include aggressive or corrosive, chemical components. Examples of such products are perfumes and air fresheners.

Another object of the invention is to provide a packaging material which is significantly more economical and convenient to create performed holes and remove the holes with ease. A further object of the invention is to provide a packaging material which is able to create a plurality of preformed holes on either a same plane or different planes of the package.

These and other objects and advantages of the invention are satisfied by providing a packaging material, comprising:

a breakable film; and

a substrate on which the breakable film is positioned, wherein the substrate comprises a chemically resistant and non-heat sealable (NHS) layer having a first surface and a second surface, and a heat sealable (HS) layer bonded to the first surface of the NHS layer, and the breakable film is laminated onto the second surface of the NHS layer, and wherein at least one die cut line to define a preformed hole is formed through the NHS and HS layers.

In one particularly preferred embodiment, the breakable film comprises or consists of aluminum foil.

The NHS layer may comprise nylon, polyesters preferably polyethylene terephthalate, or combination thereof.

The HS layer may comprise one or more polyolefin-based material. In one specific embodiment, the HS layer comprises polyethylene, polypropylene or combination thereof.

To provide the ease of removing the preformed holes, one or more points of connection may be arranged on the die cut line for linking an area bound by the die cut line and the rest of the packaging material. It is advantageous that the preformed hole is of symmetrical configuration, such as square, rectangle, circle, oval shape, hexagon, octagon or the like.

According to the invention, a feature of the packaging material is that at least one fold is formed over the preformed hole preferably along a line of symmetry of the preformed hole on the breakable film and the substrate, so that the fold formed as such includes the combination of the breakable film/NHS layer/HS layer.

A second aspect of the invention is to provide a package made of a packaging material according to the invention. The package is capable of containing aggressive, or corrosive, chemical components due to its good resistance to chemicals.

According to one example of the invention, the package comprises two sheets of the packaging material, which are bonded together by heat sealing along a periphery of the package.

A third aspect of the invention relates to a method for constructing a package, comprising the steps of:

bonding a first surface of a chemically resistant and non-heat sealable (NHS) layer to a heat sealable (HS) layer so as to provide a substrate;

die-cutting the substrate through the NHS and HS layers to form at least one preformed hole;

laminating a second surface of the NHS layer onto a breakable film to afford a packaging material; and

heat sealing two sheets of the packaging material with their respective HS layers facing with each other along a periphery of the package.

Advantageously, the method further comprises the step of forming a fold over the preformed hole on the breakable film and the substrate, prior to the heat sealing step.

The method of the invention may further comprise the step of arranging one or more points of connection on a die cut line defining the preformed hole between an area of the preformed hole and the rest of the packaging material.

In contrast to the packaging materials available in the prior art, the packaging material of the invention utilizes a combination of a breakable aluminum foil and a substrate that exhibits excellent chemical resistance, with at least one fold over the preformed hole being created. The fold acts as a handle to enable the user to create the hole with ease. Further, the folds and the preformed holes can be formed on different planes of the package, allowing the user to regulate the release level of the contents packaged therein by opening the corresponding number of the preformed holes. Therefore, the package of the invention is low in cost, flexible to use and reliable for the aggressive or corrosive products.

To have a better understanding of the invention reference is made to the following detailed description of the invention and embodiments thereof in conjunction with the accompanying drawings.

### BRIEF DESCRIPTION OF THE DRAWINGS

FIG. 1 is a cross sectional view of a substrate of a packaging material constructed in accordance with an embodiment of the invention.

FIG. 2 is a cross sectional view of the substrate shown in FIG. 1, with a die cut line to define a preformed hole.

FIG. 3 is a front view of the preformed hole defined by the die cut line shown in FIG. 2.

FIG. 4 is a cross sectional view of an aluminum foil laminated onto the substrate shown in FIGS. 2 and 3.

FIG. 5 is a schematic view showing how an opening is created on the packaging material.

FIG. 6 is a cross sectional view showing a process for forming a fold over the preformed hole.

FIG. 7 is a perspective view of the process of FIG. 6.

FIG. 8 is a schematic view showing a process for forming a package using the packaging material of FIGS. 1 to 6 according to one embodiment of the invention.

FIG. 9 are views of front and back sides of the package shown in FIG. 8.

FIG. 10 is a schematic view showing how to use the package shown in FIGS. 8 and 9.

FIG. 11 is a schematic view showing a process for forming a package using the packaging material of FIGS. 1 to 6 according to another embodiment of the invention.

FIG. 12 are views of front and back sides of the package shown in FIG. 11.

FIG. 13 is a schematic view showing how to use the package shown in FIGS. 11 and 12.

In the various figures of the drawings, like reference numbers are used to designate like parts.

### DETAILED DESCRIPTION OF THE PREFERRED EMBODIMENTS

While this invention is illustrated and described in preferred embodiments, the packaging material and the package made of the packaging material may be produced in many different configurations, sizes, forms and materials.

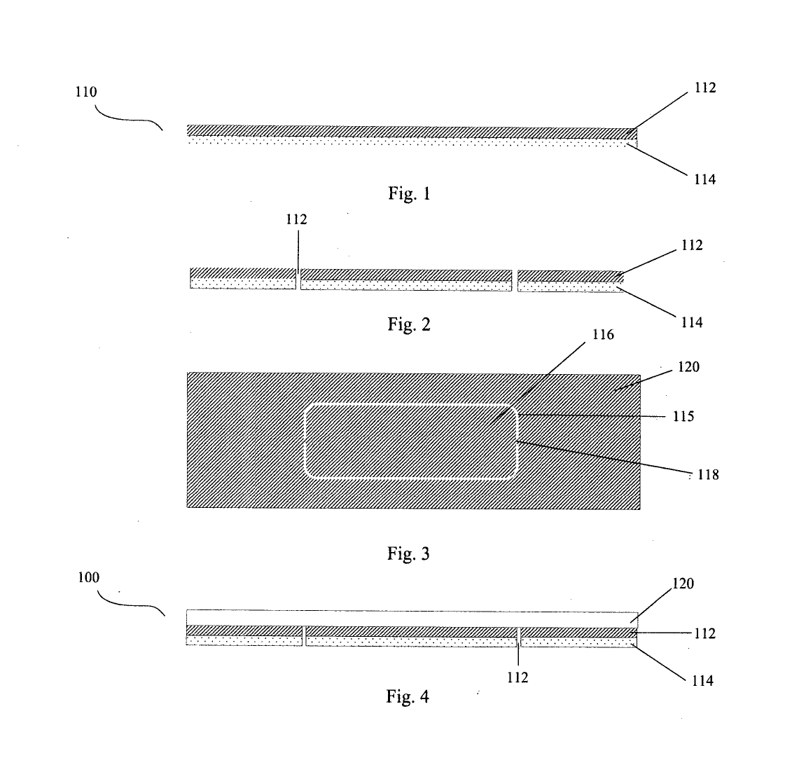

Referring now to the drawings, FIGS. 1 to 4 provide a packaging material 100 constructed consistent with a preferred embodiment of the present invention. In this embodiment, the packaging material 100 comprises a substrate 110 made up from a non heat sealable (NHS) layer 112 and a heat sealable (HS) layer 114 that is bonded to a first surface of the NHS layer 112 by means of any method known in the art. The material for the NHS layer 112 is selected such that the NHS layer 112 is chemically resistant or flavor resistant. For example, the NHS layer 112 may comprise nylon, polyesters preferably polyethylene terephthalate, or combination thereof. The HS layer 114 may comprise a polyethylene-based material, a polypropylene-based material, or combination thereof, and preferably the HS layer 114 comprises polyethylene, polypropylene or combination thereof. The respective thickness of the NHS and HS layers varies with the application of the package, and may be in the range of 1 to 50 microns.

The HS layer is used to be bonded by heat sealing to the HS layer of another sheet of the packaging material to form a package container such as a packaging bag. Due to its resistance to chemical components, the NHS layer is used to couple the HS layer to the aluminum foil, preventing these two layers from delaminating upon contact with aggressive components, such as air freshener ingredients.

After the lamination of the NHS layer 112 onto the HS layer 114 to provide the substrate 110, the substrate 110 is subject to a die-cutting process where one or more preformed holes 116 are created to extend through both the NHS and HS layers 112, 114, as shown in FIG. 2. In particular, a die-cut line 115 is formed to define a preformed hole in symmetric shape, for example square, rectangle, circle, oval shape, hexagon, octagon or the like. The symmetric preformed hole preferably has two or more lines of symmetry such that the fold will be formed along one line of symmetry, which will be described hereinbelow. The symmetric shape ensures that the tear lines can be created easily on the fold and propagate along the lines of weakness to create an opening. A plurality of preformed holes of various configurations may be created according to the actual needs.

As can be seen from FIG. 3, instead of a thorough cut, the substrate is die cut such that one or more narrow points 118 of connection along the die cut line 115 for linking the area bound by the die cut line 115 and the rest of substrate. The narrow points 118 of connection are usually at the center of the edge of the area. In this embodiment, the area bounded by the die cut line (i.e. this area corresponding to the preformed hole) is rectangular, and the narrow points 118 of connections are arranged in the center of the four straight edges of the rectangle.

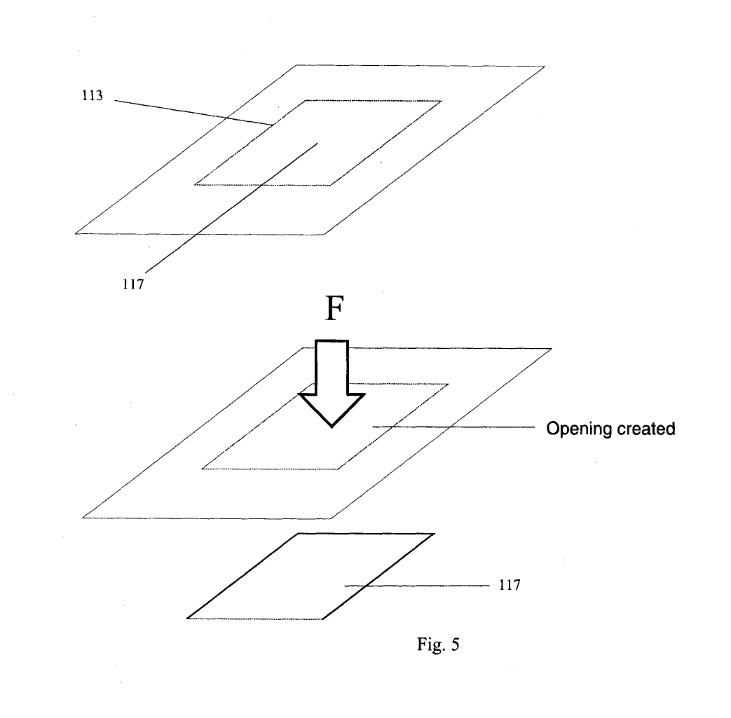

After the die cut process is completed, the substrate 110 is ready to be laminated onto a breakable or piercible aluminum foil. In particular, the second surface of the NHS layer 112 that is opposite to the first surface is laminated onto the aluminum foil 120. Since the aluminum foil 120 is breakable, the area of the aluminum foil 120 just above the die cut line 115 of the substrate 110 and covering the preformed hole becomes a line 113 of weakness which represented by dotted line in the figures. The line 113 of weakness defines an area 117 of weakness and provides a mechanism by which the user can tear open the package along a predetermined opening trajectory. When a light pressure for example a force F is applied to the area 117 of weakness, the entire portion of the weakness area of the packaging material would be easily pushed out to create an opening, as shown in FIG. 5.

FIG. 4 clearly illustrates that there is no opening formed on the aluminum foil 120. This maintains the integrity of the package and prevents the products in the package from escaping to outside.

The packaging material of the invention is now complete and can be formed into any shape that is useful for packaging and holding a product, such as bags or sachets.

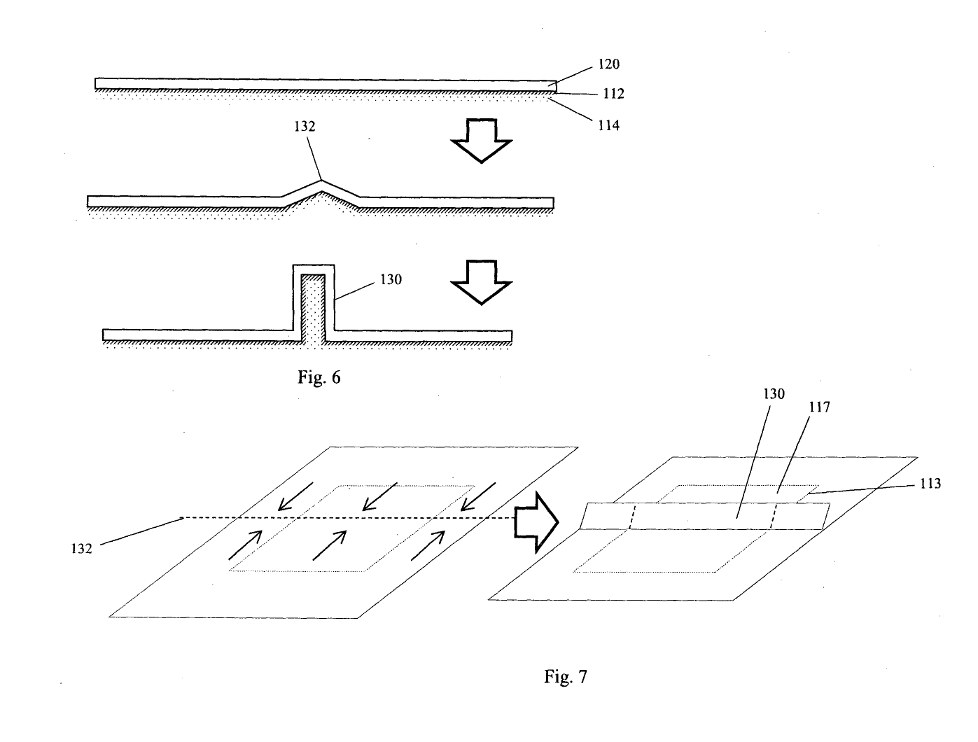

FIGS. 6 and 7 illustrate the formation of a fold 130 over the preformed hole on the complete packaging material formed from the lamination of the aluminum foil 120 and the substrate 110. As illustrated, the aluminum foil 120, the NHS layer 112 and the HS layer 114 all are folded relative to a folding line 132 along the directions of folding shown in FIGS. 6 and 7 over the preformed hole to form the fold 130. The fold 130 is provided on an outer surface of the aluminum foil 120, and eliminates the need of an external aid for opening the package. Although these figures illustrate the formation of one preformed hole and one fold over the hole, it would be understood that more than one preformed hole and more than one fold are possible.

The fold 130 acts as a handle for the user to remove the preformed hole along the line of weakness. The die cut line 115 extends from the preformed hole into the fold, allowing the user to initiate the tear from the points of intersection of the edge of the fold 130 and the die cut line 115. In this embodiment, the rectangular preformed hole 116 has two straight lines which allow formation of two continuous die cut lines from the area bound by the die cut lines through the fold 130.

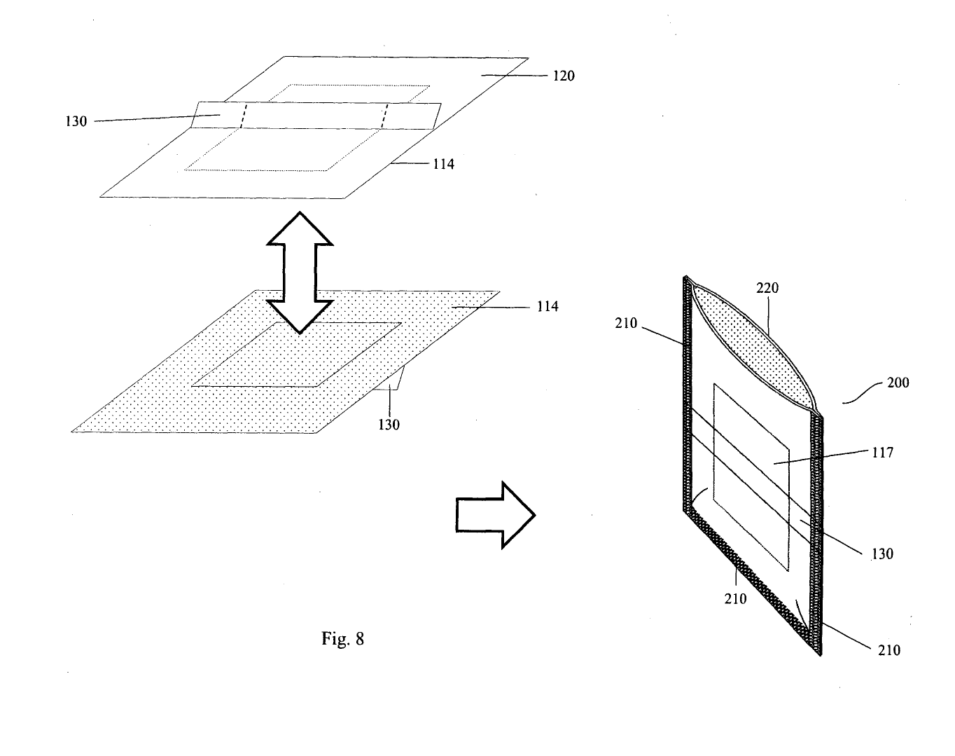

Turning now to FIGS. 8 to 10, there is illustrated a process for making a package 200 using the package material 100 constructed as above. The package 200 is formed by heat sealing two sheets of the packaging material 100. In particular, the two sheets of the packaging material 100 are placed oppositely, with their respective HS layer 114 facing with each other. The HS layers 114 of the packaging material 100 allow heat sealing of the two sheets of packaging material to occur. The three sides of the sheets are first subjected to the heat sealing 210 to close these three sides, leaving one side 220 to be open for insertion of the product into the package. The fold 130 formed on the outer surface of the aluminum foil 120 would be flattened during the heat sealing. After the product is inserted into the package through the open side 220, this side is also heated seal to close the package 200 permanently (see FIG. 8). In this way, the package 200 may remain completely sealed prior to the creation of the openings by breaking or piercing the preformed holes.

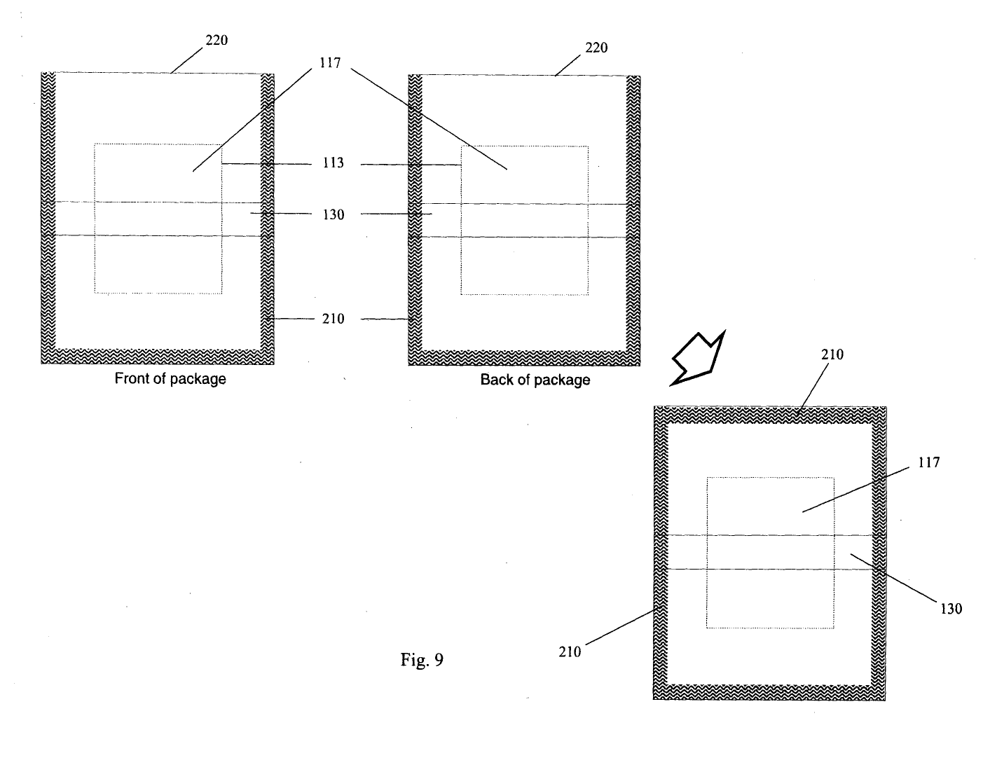

As illustrated in FIG. 9, since one or more preformed holes can be formed on each sheet of the packaging material 100, the package 200 produced by the two sheets of the packaging materials 100 would have one or more preformed holes and corresponding folds on its front and back sides, allowing the user to decide how many openings should be created at the point of usage. This is particularly beneficial for containing perfumes and air fresheners. The openings allow the fragrances from the perfumes or air freshener to be released from the package. The user may create the openings on the package as many as he/she likes, so as to adjust the fragrance strength. The more openings the higher level of fragrance is released, hence a higher fragrance intensity is experienced.

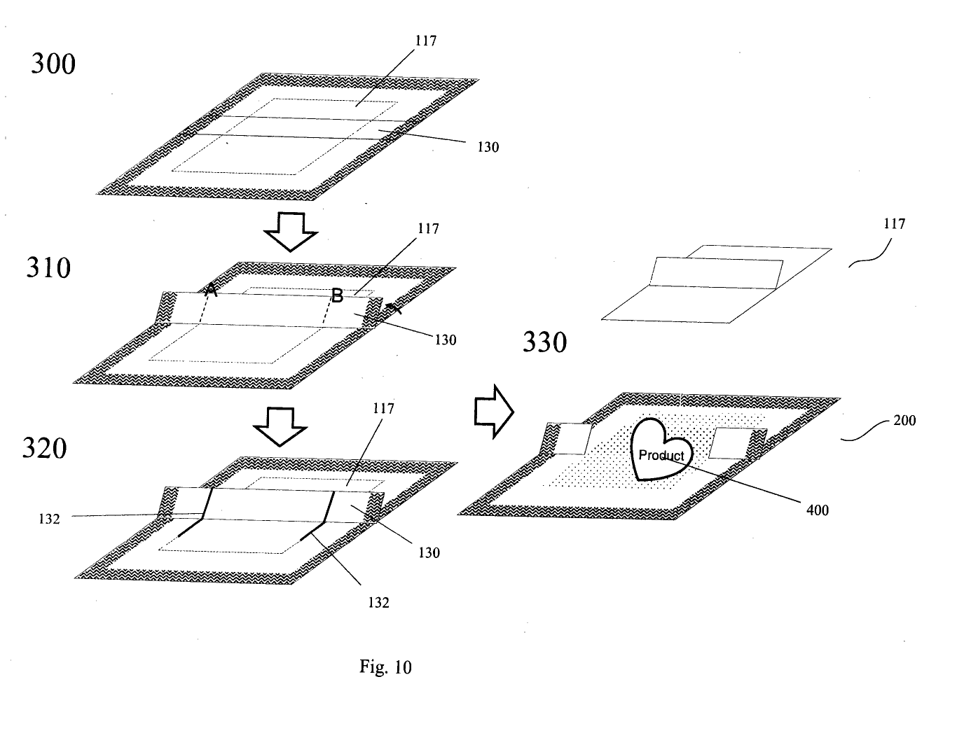

FIG. 10 illustrates the way how to create the openings on the package 200. Step 300 represents a completely sealed package with an air freshener 400 packaged therein. To create an opening, the fold 130 provided on the outer surface of the aluminum foil 120 is lifted up to initiate tear at points A and B from which points the package would be teared along the entire line of weakness (see steps 310 and 320). Once the entire line of weakness is teared, holding onto the fold 130 allows for the area 117 of weakness to be lifted off entirely (see step 330). This creates an opening 332 on the package through which the product is exposed and released. The creation of the openings does not need any skin contact between the user and the product. The same can be done on the other side of the package.

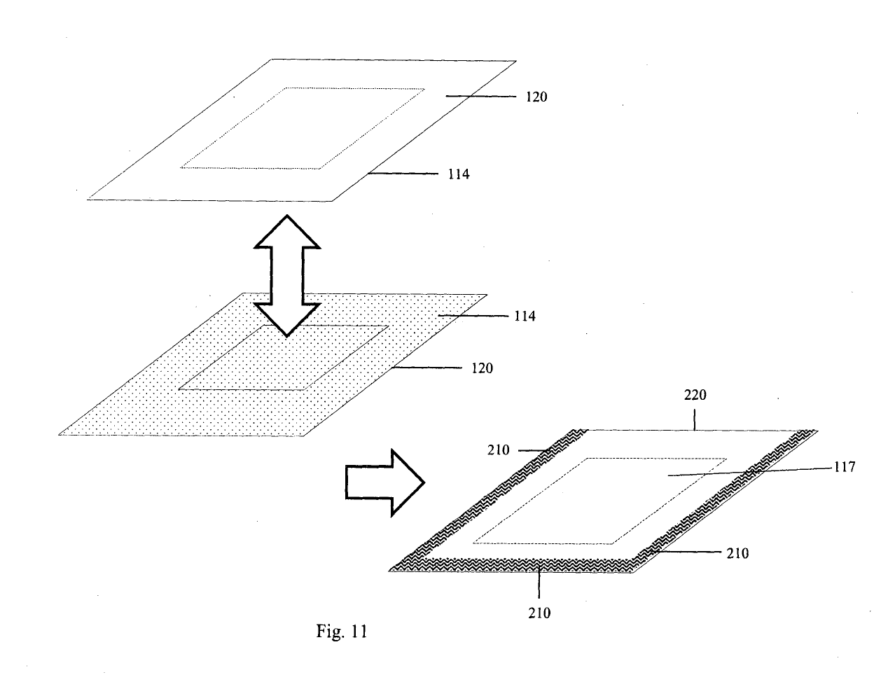

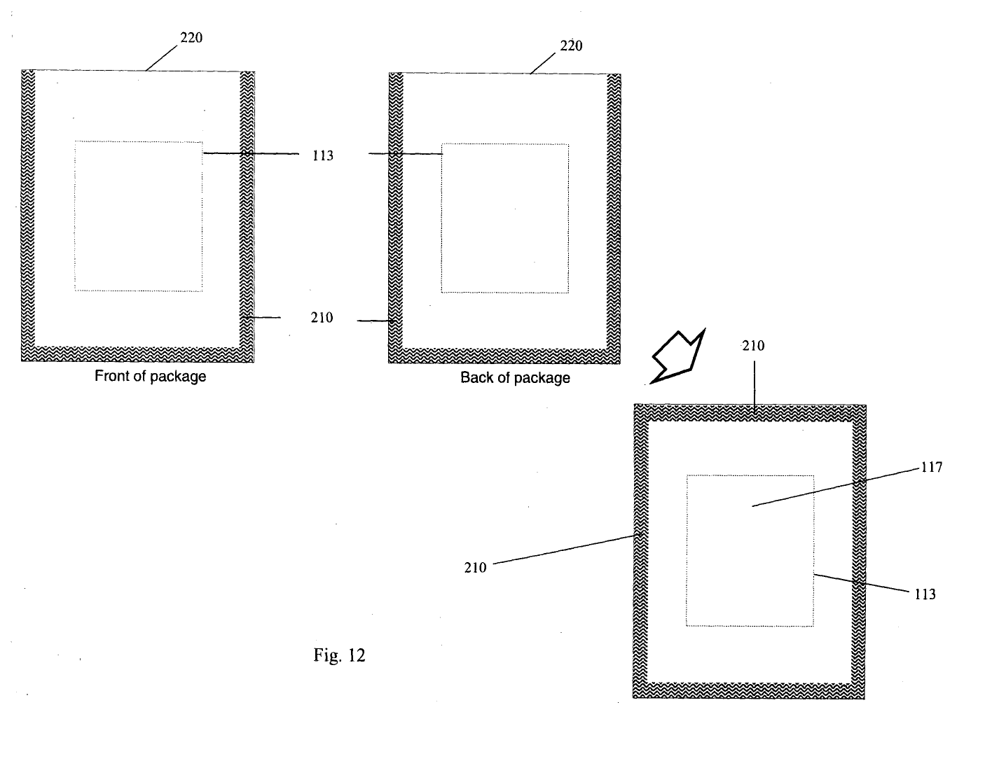

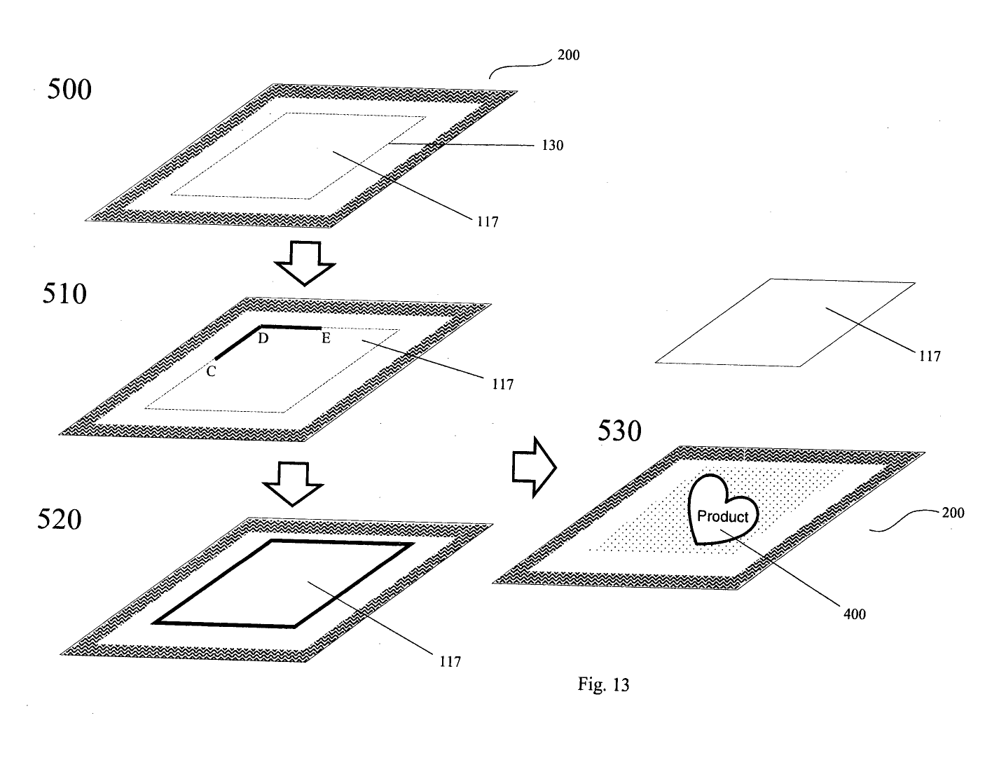

FIGS. 11 to 13 illustrate another process for making a package 200 using the package material 100 constructed as above. As can be seen, this process is substantially same as the process discussed above, but differs in the elimination of forming a fold over the preformed hole on the breakable film and the substrate, prior to the heat sealing step. In this process, step 500 represents a completely sealed package with a product therein. To create an opening, a downward pressure is applied onto the package along the line of weakness to initiate tear along a part of the line of weakness, for example defined by Points C-D-E, and then the complete tear is created along the entire line of weakness (see steps 510 and 520). Once the entire line of weakness is teared, the area 117 of weakness of the package is lifted off entirely (see step 530). This creates an opening 332 on the package through which the product is exposed and released. The same can be done on the other side of the package. Again, the creation of the openings in the process of the process does not need any skin contact between the user and the product.

As described above, the packaging material of the invention is highly resistant to chemical components due to the incorporation of the NHS layer, and thus suitable for the package containing aggressive or chemical products, such as perfumes and air fresheners. The chemical ingredients present in the air fresheners such as limonene cannot permeate the packaging material during transportation and storage or prior to the usage of the product, and do not cause damage to the package. This ensures the integrity of the package and of the product during storage.

The packaging material of the invention may have a plurality of preformed holes, so the package produced from the packaging material may be conferred with the plurality of preformed holes on its front and back sides, allowing the user to regulate the release level of the product in various directions of both sides during usage by opening the desired number of the preformed holes with ease.

The invention thus provides a packaging material which is a flexible, reliable and low cost to manufacture, and which exhibits good chemical resistance.

While the embodiments described herein are intended as an exemplary packaging material and package, it will be appreciated by those skilled in the art that the present invention is not limited to the embodiments illustrated. Those skilled in the art will envision many other possible variations and modifications by means of the skilled person's common knowledge without departing from the scope of the invention, however, such variations and modifications should fall into the scope of this invention.

1. A packaging material for making packages, comprising:
a breakable film; and
a substrate on which the breakable film is positioned, wherein the substrate comprises a chemically resistant and non-heat sealable (NHS) layer having a first surface and a second surface, and a heat sealable (HS) layer bonded to the first surface of the NHS layer, and the breakable film is laminated onto the second surface of the NHS layer, and wherein at least one die cut line to define a preformed hole is formed through the NHS and HS layers.

2. The packaging material as claimed in claim 1, wherein the breakable film comprises or consists of aluminum foil.

3. The packaging material as claimed in claim 1, wherein the NHS layer comprises nylon, polyesters or combination thereof.

4. The packaging material as claimed in claim 3, wherein the polyester is polyethylene terephthalate.

5. The packaging material as claimed in claim 1, wherein the HS layer comprises one or more polyolefin-based material.

6. The packaging material as claimed in claim 5, wherein the HS layer comprises polyethylene, or polypropylene or combination thereof.

7. The packaging material as claimed in claim 1, wherein one or more points of connection are arranged on the die cut line for linking an area bound by the die cut line and the rest of the packaging material.

8. The packaging material as claimed in claim 1, wherein the preformed hole is of symmetrical configuration.

9. The packaging material as claimed in claim 1, wherein at least one fold is formed over the preformed hole on the breakable film and the substrate.

10. The packaging material as claimed in claim 9, wherein the at least one fold is formed along a line of symmetry of the preformed hole.

11. A package made of a packaging material according to claim 1.

12. The package as claimed in claim 11, wherein the package contains aggressive, or corrosive, chemical components.

13. The package as claimed in claim 11, wherein the package comprises two sheets of the packaging material comprising:
a breakable film; and
a substrate on which the breakable film is positioned, wherein the substrate comprises a chemically resistant and non-heat sealable (NHS) layer having a first surface and a second surface, and a heat sealable (HS) layer bonded to the first surface of the NHS laver, and the breakable film is laminated onto the second surface of the NHS laver, and wherein at least one die cut line to define a preformed hole is formed through the NHS and HS layers, which are bonded together by heat sealing along a periphery of the package.

14. A method for constructing a package, comprising the steps of:
bonding a first surface of a chemically resistant and non-heat sealable (NHS) layer to a heat sealable (HS) layer to provide a substrate;
die-cutting the substrate through the NHS and HS layers to form at least one preformed hole;
laminating a second surface of the NHS layer onto a breakable film to afford a packaging material; and
heat sealing two sheets of the packaging material with their respective HS layers facing with each other along a periphery of the package.

15. The method as claimed in claim 14, further comprising the step of forming a fold over the preformed hole on the breakable film and the substrate, prior to the heat sealing step.

16. The method as claimed in claim 14, wherein one or more points of connection are arranged on a die cut line between an area of the preformed hole and the rest of the packaging material.

17. The method as claimed in claim 14, wherein breakable film comprises or consists of aluminum foil, the NHS layer comprises nylon or polyethylene terephthalate, and the HS layer comprises polyethylene, polypropylene or combination thereof.

18. The method as claimed in claim 15, wherein breakable film comprises or consists of aluminum foil, the NHS layer comprises nylon or polyethylene terephthalate, and the HS layer comprises polyethylene, polypropylene or combination thereof.

19. The method as claimed in claim 16, wherein breakable film comprises or consists of aluminum foil, the NHS layer comprises nylon or polyethylene terephthalate, and the HS layer comprises polyethylene, polypropylene or combination thereof.

20. The package as claimed in claim 11, wherein one or more points of connection are arranged on the die cut line of the material for linking an area bound by the die cut line and the rest of the packaging material.
